(19) United States
(12) Patent Application Publication
(10) Pub. No.: US 2003/0145250 A1
(43) Pub. Date: Jul. 31, 2003

(54) Dynamic built-in self-skip method used for shared memory fault recovery

(76) Inventor: Wen-Long Chin, Hsinchu (TW)

Correspondence Address: MARTINE & PENILLA, LLP, 710 LAKEWAY DRIVE, SUITE 170, SUNNYVALE, CA, 94085, US

(21) Appl. No.: 10/126,839

(22) Filed: Apr. 19, 2002

(30) Foreign Application Priority Data
Jan. 29, 2002 (TW) 91101528

(51) Int. Cl. H04B 1/74

(52) U.S. Cl. 714/30

(57) ABSTRACT

The present invention relates to a dynamic built-in self-skip method used for shared memory fault recovery. The method employs the mapping relationship between the packet buffer and free link table under the shared memory structure. First, we record the blocks in the free link table corresponding to the defective rows in the packet buffer without carrying out initialization to the blocks recorded as fail, so that they do not enter the package switching activity. Therefore the defective rows of the memory mapping to fail blocks do not proceed with the read/write process, in other words, accomplishing the object of fault recovery. The recovery method is not dependent on the memory architecture and complex algorithms, and thus it may be easily associated with designs of various systems and increases chip yield.

### BACKGROUND OF THE INVENTION

1. Field of the Invention

The invention relates to a method for shared memory fault recovery, and more particularly, to a dynamic built-in self-skip method used for shared memory fault recovery.

2. Description of the Related Art

In the realm of Internet communication, designers are prone to adopt shared memory structure in switch controller designs. The shared memory structure consists of two parts: a greater part of the memory capacity is used as packet buffer, and the other smaller part is used to store linked-list pointer.

FIG. 1 shows the relationship between the packet buffer 101 and the free link table 102 under the shared memory structure. Referring to FIG. 1, blocks in the free link table 102 show a one-to-one mapping relationship with the packet buffer 101. For example, the block 0 in the free link table 102 corresponds to packet buffer address 0 to i-1, the block 1 in the free link table 102 corresponds to packet buffer address i to 2i-1, and so forth. On receiving, data are stored in the packet buffer 101 and its corresponding blocks in the free link table 102 are exhausted. On transmitting, data are read from the packet buffer 101 and its corresponding blocks in the free link table 102 are returned.

To integrate more ports on a same multi-port network switch controller, we need to use much larger memory as our packet buffer. However, embedding more memory on the chip complicates the fabrication process and then raises its cell density, thereby significantly increasing the hazard of defective memory and apparently lowering the chip yield.

To find the defects of the memory, a built-in self-test circuit is generally adopted for testing. In order to solve the drop in chip yield caused by defects of the memory, the reservation of a redundancy circuit on the chip is attempted. The memory thereof can be used to replace and recover a certain region when defects thereon occur. Referring to FIG. 2, a circuit is shown implementing a conventional row redundancy scheme. The circuit comprises a row decoder 202, a word line driver 204 used to select regular rows, a word line driver 205 used to select redundant rows, a fuse block 203, and a redundant row programming logic 206. Each regular row of the memory array 201 has a disable fuse (e.g., fuse block 203). If a particular row is faulty, the respective disable fuse is blown using laser and so on, so that the defective row is unable to continue with the read/write process. The redundant row programming logic 206 then selects a free redundant row encoding position, transmitting the signal to the word line driver 205 to select the reserved redundant row of the memory for replacement, thereby accomplishing the object of fault recovery.

Nevertheless, the above recovery method requires complex repair algorithms and strongly depends on memory architecture. Besides, it needs additional non-volatile storage to store those failure addresses, and its area penalty is about 3% or more; moreover, memory access time may be affected.

### SUMMARY OF THE INVENTION

In view of the above, the object of the invention is to provide a dynamic built-in self-skip method used for shared memory fault recovery. The execution thereof is not dependent on the memory architecture and complex algorithms and can be easily associated with designs of various systems to increase chip yield.

In accordance with the present invention, a dynamic built-in self-skip method used for shared memory recovery comprising the following steps:

selecting a data row in a packet buffer of said shared memory to proceed with a built-in self-test, if said data row is defective, recording a block in said free link table corresponding to said data row as fail, or record as good if not;

when all said blocks in said free link table are completed with recording, reading said records of all said blocks in said free link table; and

initializing said blocks recorded as good in said free link table.

Also, the available blocks in the free link table is implemented in a first-in-first-out manner.

Or, the available blocks in the free link table is implemented as linked-list.

Further, the dynamic built-in self-skip method of present invention can be used for shared memory having a non-defect-tolerable memory segment.

In accordance with a second aspect of present invention, we identify all blocks in the free link table as good as our default situation; therefore, we only have to change the record of blocks correspond to defective rows, following the steps below:

recording all blocks in a free link table as good;

selecting a data row in a packet buffer of said shared memory to proceed with built-in self-test, if said data row is defective, changing a record of a block in said free link table corresponding to said data row as fail;

when records of all said blocks in said free link table are determined, reading said records of said blocks in said free link table; and

initializing said blocks recorded as good in said free link table.

In the present invention, the dynamic skip method is used to prohibit direct data access of memory error addresses, and hence physical repair in connection with the memory defects on the chip is not required, but to have data avoid these defective regions and to be accessed in other valid regions. Therefore the invention is not dependent on the memory architecture and complex algorithms to recover errors, and can be associated with designs of various systems, so that the system chip can continue to operate even if defects occur within the memory thereon. Consequently, the chip life span is prolonged regarding to the chip operation on the system.

### BRIEF DESCRIPTION OF THE DRAWINGS

FIG. 1 shows the mapping relationship between the packet buffer and the free link table under the conventional shared memory structure.

FIG. 2 is the schematic of an fault recovery method using the conventional redundant memory method.

FIG. 3 is the schematic showing the principle of the dynamic built-in self-skip method of the invention used for shared memory fault recovery.

FIG. 4 is the control flow diagram of the dynamic built-in self-skip method in accordance with the first embodiment of the invention.

FIG. 5 is the control flow diagram of the dynamic built-in self-skip method in accordance with another embodiment of the invention.

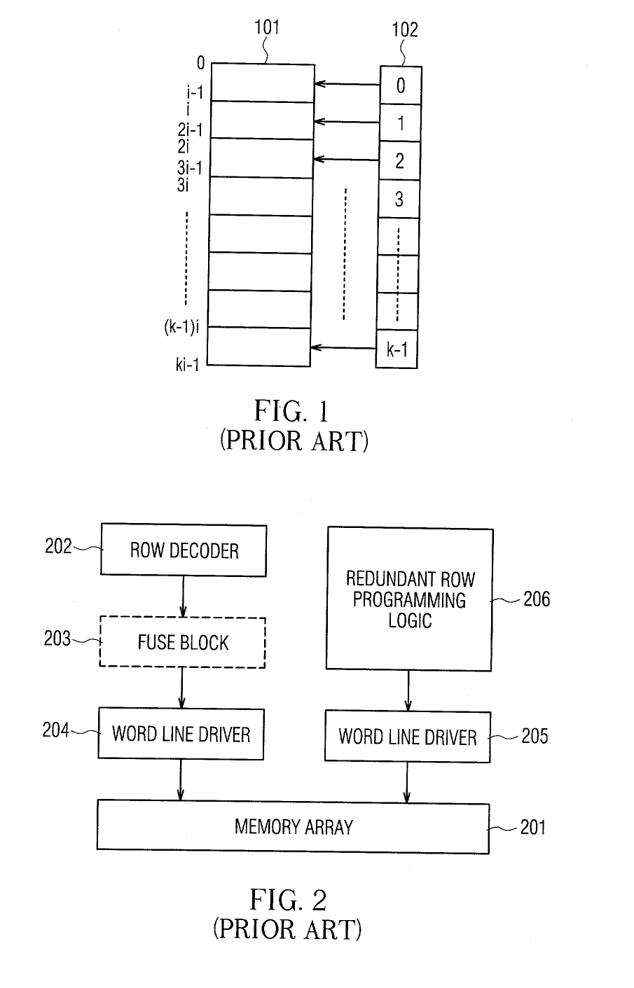

### DESCRIPTION OF THE PREFERRED EMBODIMENTS

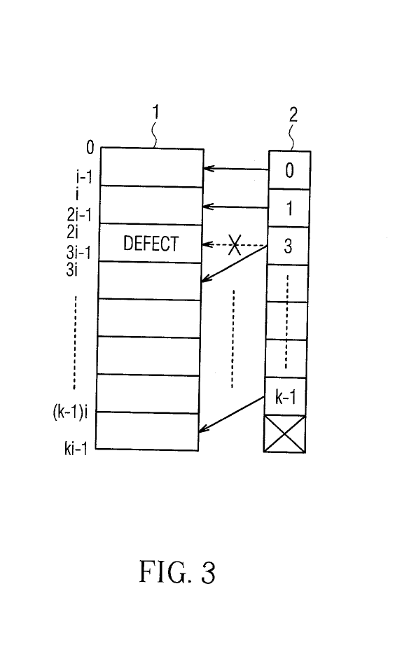

FIG. 3 is the schematic showing the principle of the dynamic built-in self-skip of the present invention recovering a shared memory error. First of all, blocks in the free link table 2 show a one-to-one mapping relationship with the data rows of packet buffer 1. Referring to FIG. 3, in which the mapping relationship is utilized. For instance, when the address from 2i to 3i-1 of the packet buffer is found defective by the built-in self-test, the block numbered as 2 in the free link table, which corresponds to the defective row of the packet buffer, will not be written into the free link table 2 at this point. That is, we initialize only the other blocks in the free link table 2 mapping to non-defective data rows in the packet buffer 1, and proceed with package switching activity. For the reason that the data rows in the packet buffer 1 have a one-to-one mapping relationship with the blocks in the free link table 2, packet data are never to enter the defective row of the packet buffer, which corresponds to the block numbered as 2. In other words, by means of this method, physical repair is not required in connection with the memory defects on the chip, but to have the data avoid these defective regions and be constantly accessed to other valid regions, and hence the chip containing the memory is able to operate persistently and achieve the object of automatic memory fault recovery.

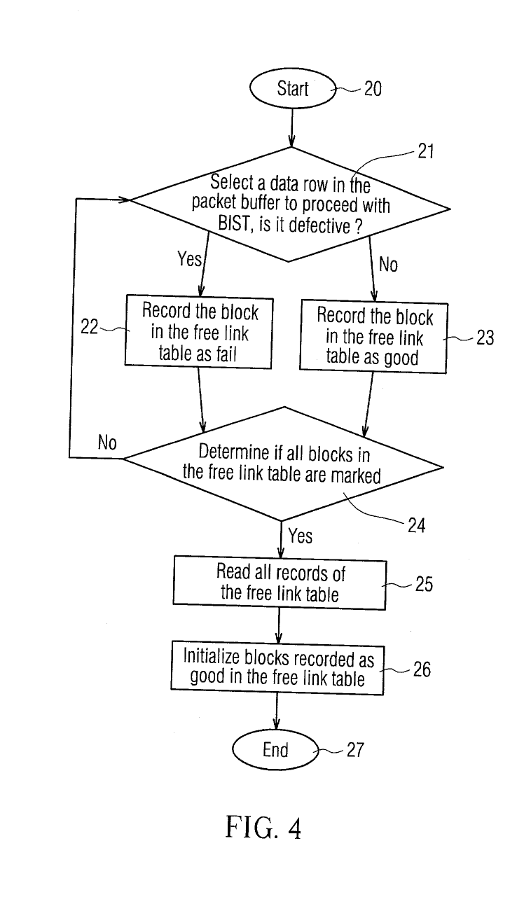

FIG. 4 is the control flow diagram of the dynamic built-in self-test method in accordance with the first embodiment of the invention. Referring to FIG. 4, the control flow of the invention includes the steps below:

step 21: Select a data row in the packet buffer of the memory to proceed with built-in self-test, to see if the data row in the packet buffer is defective, proceed with step 22 if so, or proceed with step 23 if not;

step 22: Record the block in the free link table corresponding to the data row as fail;

step 23: Record the block in the free link table corresponding to the data row as good;

step 24: Determine if all blocks in the free link table are marked, proceed with step 25 if so, or go back to step 21 if not;

step 25: Read all records of the free link table;

step 26: Initialize blocks recorded as good in the free link table to enter the subsequent package switching activity.

FIG. 4 shows the flow above, we are easily to see if the mapping packet buffer addresses are defective simply by the records of the free link table. The initialization step of the blocks recorded as fail is bypassed, and therefore the blocks do not enter the subsequent package switching activity. As a result, packet data are never to enter the defective rows of the packet buffer which correspond to the blocks recorded as fail, thereby accomplishing the object of fault recovery.

As a conclusion from the above, the present invention does not depend on the memory architecture and complex algorithms to recover error as the conventional reserved memory redundancy, but employs the mapping relationship between the packet buffer and the free link table of the shared memory to directly prohibit defective regions of the memory from accessing data by using dynamic skipping. The invention thus can be associated with designs of various systems, and when the system is activated, the method described in the invention can be executed to skip defective regions of the memory, resultantly, the system chip is still able to keep operating even if memory defects thereof occur. The chip life span is practically prolonged with respect to the chip operation. And as for the chip fabrication process, even if memory defects occur within the memory thereon, they may still be recovered by the skip method provided by the invention; in other words, the chip yield is increased.

Also, since we do not have other designs such as the disable fuse on the chip, we may save more area of the memory comparing to prior techniques.

Further, the available blocks in the free link table may be implemented in a first-in-first-out manner. As shown in FIG. 3,read and write pointers will wrap around until the k-1th block.

Also, the available blocks in the free link table may be implemented as linked-list, only to skip defective regions in the packet buffer by changing targets of the pointers.

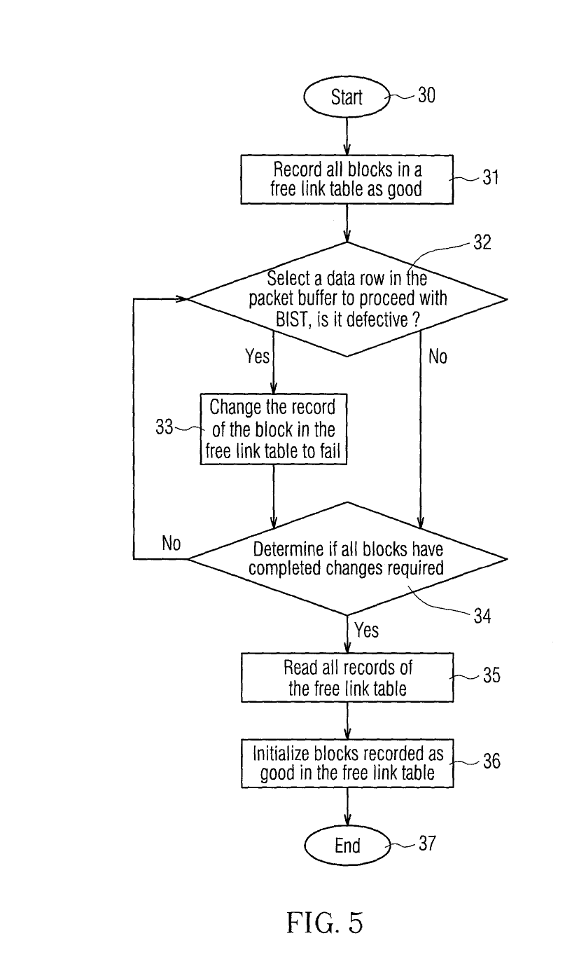

FIG. 5 shows the control flow diagram of the dynamic built-in self-skip in another embodiment of the present invention. Referring to FIG. 5, the control flow includes the following steps:

step 31: Record all blocks in a free link table as good;

step 32: Select a data row in the packet buffer of the memory to proceed with built-in self-test to see if the data row in the packet buffer is defective, proceed with step 33 if so, or proceed with step 34 if not;

step 33: Change the record of the block in the free link table mapping to the data row to fail and proceed with step 34;

step 34: Determine if all blocks in the free link table have completed changes required, proceed with step 35 if so, or go back to step 32 if not;

step 35: Read all records in the free link table;

step 36: Initialize all blocks recorded as good in the free link table to enter the subsequent package switching activity.

In accordance with the second embodiment of the invention, we identify all blocks in the free link table as good as our default situation; therefore, we only have to change the record of blocks correspond to defective rows.

In addition, non-defect-tolerable memory segments such as the address table, do not allow defects exist on shared memory. The dynamic built-in self-skip method provided by the invention may also be applied to shared memory having such non-defect-tolerable memory. For instance, the segment of the shared memory tested as good by the built-in self-test are prioritized to the non-defect-tolerable memory such as the address table, and then other parts thereof besides the non-defect-tolerable memory were provided for the packet buffer of the present invention. The packet buffer can also have the one-to-one mapping relationship with the free link table and yet tolerable for defects. In this way the initialization of the blocks in the free link table recorded as fail can also be bypassed, and thus the blocks do not enter the subsequent package switching activity. As a result, the packet data are never to enter the mapping defective rows in the packet buffer, thereby accomplishing the object of fault recovery.

The embodiment of the present invention is described in an illustrative but not restrictive sense. It is intended that the present invention may not be limited to the particular forms as illustrated, and that all modifications which maintain the spirit and realm of the present invention are within the scope as defined in the appended claims.

What is claimed is:

1. A dynamic built-in self-skip method used for shared memory recovery comprising the following steps:
selecting a data row in a packet buffer of said shared memory to proceed with a built-in self-test, if said data row is defective, recording a block in said free link table corresponding to said data row as fail, or record as good if not;
when all blocks in said free link table are completed with recording, reading said records of all said blocks in said free link table; and
initializing said blocks recorded as good in said free link table.

2. The dynamic built-in self-skip method as described in claim 1, wherein said free link table is implemented in a first-in-first-out manner.

3. The dynamic built-in self-skip method as described in claim 1, wherein said free link table is implemented as linked-list.

4. The dynamic built-in self-skip method as described in claim 1, wherein the shared memory has a non-defect-tolerable memory segment.

5. A dynamic built-in self-skip method used for shared memory fault recovery comprising the following steps:
recording all blocks in a free link table as good;
selecting a data row in a packet buffer of said shared memory to proceed with built-in self-test, if said data row is defective, changing a record of a block in said free link table corresponding to said data row as fail;
when records of all said blocks in said free link table are determined, reading said records of said blocks in said free link table; and
initializing said blocks recorded as good in said free link table.

6. The dynamic built-in self-skip method as described in claim 5, wherein said free link table is implemented in a first-in-first-out manner.

7. The dynamic built-in self-skip method as described in claim 5, wherein said free link table is implemented as linked-list.

8. The dynamic built-in self-skip method as described in claim 5, wherein the shared memory has a non-defect-tolerable memory segment.
